(19) United States
(12) Patent Application Publication
(10) Pub. No.: US 2026/0164195 A1
(43) Pub. Date: Jun. 11, 2026

(54) SYSTEM AND METHOD EMPLOYING SMART SPEAKER SELECTION FOR HEARING ENHANCEMENT

(71) Applicant: NXP B.V., Eindhoven (NL)

(72) Inventors: Luan Vinícius Fiorio, Eindhoven (NL); Ronaldus M. Aarts, Geldrop (NL); Boris Petrov Karanov, Eindhoven (NL)

(73) Assignee: NXP B.V., Eindhoven (NL)

(21) Appl. No.: 18/975,949

(22) Filed: Dec. 10, 2024

(51) Int. Cl. H04R 25/00

(52) U.S. Cl. CPC H04R 25/507; H04R 25/405; H04R 25/43; H04R 2225/41; H04R 2225/43

(57) ABSTRACT

Improved hearing systems and methods are disclosed herein. In one example embodiment, a hearing system includes memory device(s), audio input device(s) configured to receive audio input signals including audio information arising from a plurality of sound sources, audio output device(s), and processing device(s). During an inference mode, the processing device(s) are configured to operate in accordance with the first neural network to generate intermediate output signals that, to a higher degree than in the audio information, reflect or emphasize at least one desired sound source component of the audio information arising from a desired one of the sound sources of the plurality of sound sources determined to be the desired one of the sound sources at least indirectly based upon a first undershot angle evident from the audio information. The audio output device(s) are configured to generate audio output signals based at least indirectly upon the intermediate output signals.

### FIELD OF THE DISCLOSURE

The present disclosure relates to auditory prosthetics systems and methods such as hearing aids and, more particularly, to such systems and methods that employ neural networks, machine learning, or artificial intelligence.

### BACKGROUND OF THE DISCLOSURE

People experiencing hearing impairment frequently rely upon the use of auditory prosthetics or hearing systems (or hearing instruments or devices), such as hearing aids. Such hearing systems often use beamforming algorithms that enhance the sound coming from a location in front of the listener, and that suppress sounds originating from other directions. Alternatively, some conventional adaptive beamforming approaches can compensate, with the beam direction, to reduce the detrimental effect of reverberation.

More particularly, in some circumstances, the spectrum of human voices usually overlaps (e.g., in frequency and time) when the environment is noisy, or in circumstances in which there are multiple speakers. Human beings having unimpaired hearing capabilities typically can separate discrete auditory stimuli into different streams, and decide which one is most relevant, which can be defined as “selective attention.” The inability of a listener's brain to segregate stimuli as described above and to focus auditory attention upon (and to understand) a desired speaker in such a condition is sometimes referred to as the “cocktail party problem” (or “cocktail party effect” or “cocktail party deafness”). Such impairment might require for a listener to wear hearing system(s) such as hearing aids that can enhance his/her speech intelligibility and listening comfort.

In at least some conventional hearing systems, beamforming algorithms are present in those hearing systems. The beamforming algorithms are employed to extract sound(s) coming from locations in front of the listeners utilizing those hearing systems. Such hearing systems that employ such beamforming algorithms can enhance intelligibility and listening comfort for the listeners utilizing those hearing systems. Nevertheless, such hearing systems still can fail or be inadequate for listeners in circumstances or scenarios where there are multiple speakers speaking simultaneously or largely simultaneously. That is, such conventional hearing systems employing beamforming algorithms still are inadequate for addressing hearing difficulties in multi-speaker contexts or for addressing the above-referenced cocktail party problem.

For at least one or more reasons, it would be advantageous if new or improved hearing systems (or hearing instruments, hearing device, or hearing aids) and hearing methods of providing and operating such hearing systems could be developed to address one or more of the concerns described above, or to address one or more other concerns, or to provide one or more benefits.

### BRIEF DESCRIPTION OF THE DRAWINGS

FIG. 1 is a schematic illustration 100 of an arrangement of a listener (listener's head) relative to a plurality of speakers (speakers' heads) within a region surrounded by walls, which is provided to illustrate the concept of the undershot angle;

FIG. 2 is a schematic diagram illustrating an improved hearing system in accordance with an example embodiment encompassed herein;

FIG. 3 provides a schematic diagram that illustrates operation in a training mode for a deep neural network that can be employed in the improved hearing system of FIG. 2;

FIG. 4 and FIG. 5 respectively are a first timing diagram and a second timing diagram, respectively, illustrating a first example training routine and a second example training routine, respectively, for a deep neural network such as that described with reference to FIG. 3; and

FIG. 6, FIG. 7, and FIG. 8 respectively provide first, second, and third additional schematic diagrams, respectively, which illustrate first, second, and third example embodiments of improved hearing systems, respectively, which employ respective trained deep neural networks and are configured for operation in inference mode.

### DETAILED DESCRIPTION

The present inventors have recognized the above-discussed concerns associated with conventional hearing systems and methods that are intended to address hearing difficulties in multi-speaker contexts. Further, the present inventors have particularly recognized that, although conventional hearing systems and methods employing beamforming algorithms can enhance intelligibility, such conventional hearing systems and methods can be inadequate especially when the listener's head is not directly facing the desired speaker (or target talker), such that there is a nonzero angular difference or “undershot angle” between the direction faced by the listener's head and the direction of the location of the desired speaker. In such circumstances, when the listener's head is out of alignment with the location of the desired speaker such that there is a nonzero undershot angle, the effectiveness (e.g., real world effectiveness in terms of allowing the listener to hear and understand the desired speaker) of a conventional hearing system or method utilized by the listener can be limited.

In view of the above-described considerations, the present inventors have additionally recognized that a new or improved hearing system or method will be achieved if that new or improved hearing system or method can take into account any misalignment or nonzero undershot angle between the direction faced by a listener's head and the location of the desired speaker. In this regard, the present inventors have also recognized that head movement information is embedded in the audio data captured by a hearing instrument's (e.g., the hearing aid's) microphones, and that such head movement information extracted from the embedded phase in the hearing instrument's microphones can be used to create a strategy for desired speaker selection (without any additional measurement being utilized). Further, the present inventors have recognized that such a hearing system or method can mitigate the cocktail party problem by improving the speech intelligibility in real environments and in terms of coping with noise (e.g., undesired human speakers, reverberation, reflections, and echoes), without the use of a head-tracker or an eye-tracker, by using a pre-learned neural network (e.g., Wave-U-Net or any other suitable network, real- or complex-valued) or, alternatively, by using a beamforming filter aided by a neural network (e.g., a minimum variance distortionless response (MVDR) filter where the signal's statistics are calculated by neural networks).

Thus, the present disclosure envisions a variety of embodiments that employ, for example, either an end-to-end neural network solution or different types of beamforming that partly use a neural network. Further, the present inventors have also recognized that such a new or improved hearing system or method taking into account such misalignment or nonzero undershot angle can be achieved through the implementation, by a smart speaker selection training mechanism, of deep learning-based beamforming that allows for smart desired speaker selection (or “deep learning-based smart speaker selection beamforming”), even when the listener does not face the desired speaker (or target talker). Such smart desired speaker selection operation can enable such a hearing system or method to automatically determine, in a circumstance when there are multiple speakers, which of those speakers is the desired speaker. Although the present disclosure encompasses new or improved hearing systems or methods that are particularly applicable for implementation in or as part of hearing aids, the present disclosure also encompasses new or improved hearing systems or methods that are suitable for various other applications and contexts such as tele-conferencing, public address systems, or within enclosed spaces such as in an automobile.

Accordingly, in at least some embodiments, the present disclosure relates to new or improved hearing systems or methods that operate to eliminate or mitigate the cocktail party problem by implementing a deep/machine learning-based smart speaker selection mechanism (or a mechanism employing machine learning, or artificial intelligence). At least some embodiments encompassed herein employ a deep learning-based smart speaker selection mechanism that employs a neural network model that learns, through training, how to determine which speaker (when several are present) should be taken as the desired speaker (or target talker) at any given moment in time. Depending upon the embodiment, any of a variety of types of neural networks or related technologies can be employed including, for example, artificial neural networks (ANNs), machine learning models, convolutional neural networks (CNNs), reinforcement learning models, deep neural networks (DNNs).

Also, at least some embodiments encompassed herein employ a method involving a training mechanism where the desired speaker is changed based on the movement of the listener's head. Such a training scheme can be applied to an end-to-end neural network system, or alternatively to a system where, for example, a neural network estimates the coefficients of a linear filter or the statistics of a known beamforming filter. Upon being trained in this manner, then the neural network, when operating in inference mode, can determine (or assist in determining) or change the speaker upon which the hearing system (or device) or method should focus, according to the head movement of the listener. That is, this approach teaches the neural network to follow the spatial information, embedded in the multi-input audio signals, during inference, so as to make a smart choice of the desired speaker in circumstances ranging from simple cases with only two speakers up to a “cocktail party” situation in which there are many (e.g., more than two) speakers. In terms of beamforming, this means that optimal beamforming can be obtained without any prior information on the room size, number of speakers, noise statistics, etc.

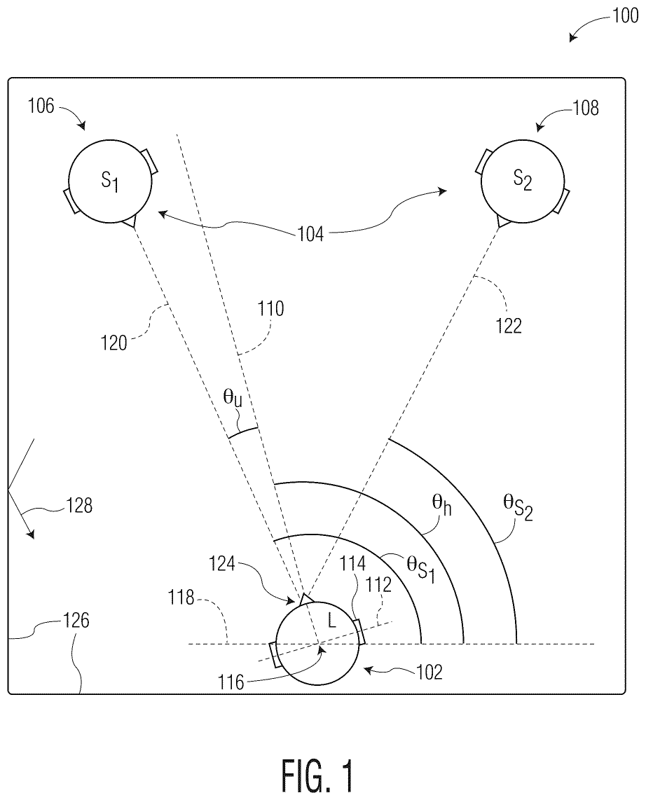

As mentioned above, embodiments of the present disclosure particularly take into account the undershot angle. In this regard, FIG. 1 provides a schematic illustration 100 to illustrate more clearly the concept of the undershot angle in a circumstance where there are two speakers who are present. More particularly, FIG. 1 shows a schematic representation of a listener's head 102, that is, the head of a listener (L) (e.g., a person who is listening for sounds) relative to a plurality of speakers' heads 104 that in this example includes a first speaker's head 106 and a second speaker's head 108, that is, the head of a first speaker (S₁) and the head of a second speaker (S₂). As shown, at any given time, the listener's head 102 has associated therewith a listener center axis 110 that can be defined as an axis proceeding directly forward of a center point 116 of the listener's head 102, and that is perpendicular to an ear-to-ear axis 112 extending between ears 114 on opposite sides of the listener's head. The listener center axis 110 can be said to form a head angle θₕ relative to a reference axis 118 and that extends through the center point 116 through the listener's head 102, through which pass each of the listener center axis 102 and the ear-to-ear axis 112.

Further as shown, assuming that respective sounds (e.g., vocalized sounds) are emitted from each of the first speaker's head 106 and the second speaker's head 108, respectively, toward the listener's head 102, then those respective sounds proceed generally along a first axis 120 and a second axis 122, respectively (which respectively are axes extending directly out of the respective fronts of those respective speakers' heads), toward the listener's head 102. Each of the first axis 120 and the second axis 122 can be said to have a respective angle associated therewith relative to the reference axis 118, namely, θₛ_{₁} and θₛ_{₂}, respectively, which can be considered the respective angles of arrival of sounds from the first speaker's head 106 and the second speaker's head 108 at the listener's head 102. In the illustration shown, it can be seen that the first axis 120 and the second axis 122 respectively extend between a tip of a nose 124 of the listener's head 102 and each of the first speaker's head 106 and the second speaker's head 108, respectively. However, the first axis 120 and the second axis 122 respectively, can also be understood to extend between the center point 116 of the listener's head 102 and each of the first speaker's head 106 and the second speaker's head 108, respectively (or respective center points thereof). It should be appreciated that, although the sounds communicated from the first speaker's head 106 and the second speaker's head 108 generally proceed along the first axis 120 and the second axis 122, sounds can reach the listener's head 102 in other manners as well, such as due to reverberation of the sounds as a result of surrounding walls 126 as represented by an arrow 128. Additionally, the first speaker's head 106 and/or the second speaker's head 108 may optionally not face directly the listener's head 102.

In the embodiment shown in FIG. 1, it can be appreciated that the first axis 120 passing through the first speaker's head 106 is angularly closer to the listener center axis 110 than is the second axis 122 passing through the second speaker's head 108. Correspondingly, the first speaker (S₁) rather than the second speaker (S₂) should be considered the desired speaker. Given this to be the case, the undershot angle θᵤ is hereby defined as the angle between the listener center axis 110 and the axis extending between the listener's head 102 and the head of the desired speaker, which in this example is the first axis 120 extending between the listener's head 102 the first speaker's head 106. That is, the undershot angle θᵤ can be defined as the angle between the listener center axis 110 of the listener (L) and the axis extending between the listener's head 102 and the sound emitting source of the desired speaker (which in this example is the first speaker (S₁)), which constitutes the angle of arrival of the closest speaker to the listener center axis. Therefore, in the present example, with the reference 118 serving as a reference axis relative to which the angular positions of other axes can be measured, and taking into account that the first axis 120 (representing the angle of arrival of sounds emitted the by first speaker) is angularly closer to the listener center axis 110 than the second axis 122 (representing the angle of arrival of sounds emitted by the second speaker), then the undershot angle can be defined as the difference between the angle of the first axis 120 relative to the reference axis 118 and the head angle θh (again, the angle between the listener center axis 110 and the reference axis), as shown in Equation (1), namely:

$${θ}_{u} = {θ}_{{S}_{1}} - {θ}_{h} . \qquad ( 1 )$$

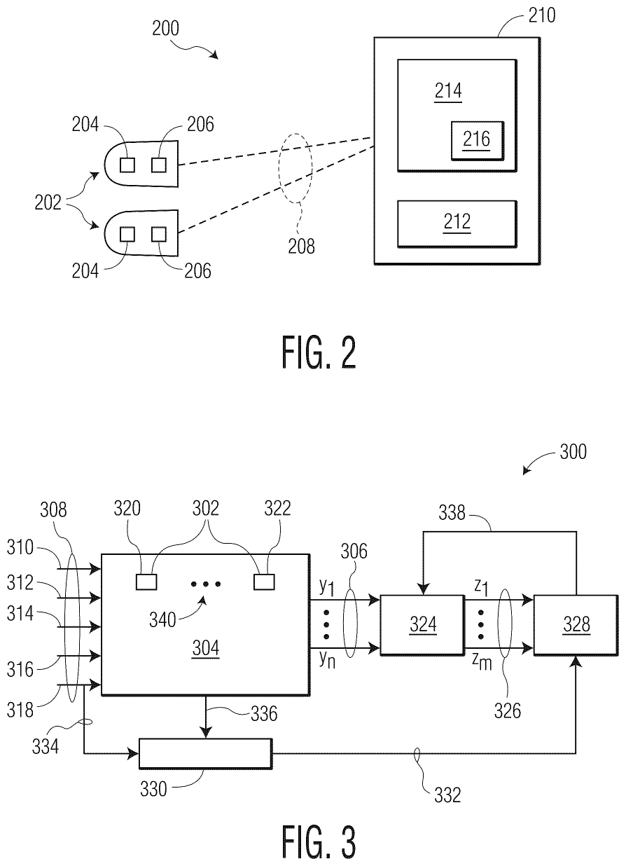

Turning to FIG. 2, the present disclosure relates to improved hearing systems and methods that utilize the above-described undershot angle concept including, for example, an example improved hearing system 200. FIG. 2 particularly provides a block diagram to illustrate in schematic form the example hearing system. In this regard, the hearing system 200 can be considered a hearing aid as can be at least partly worn by a person (e.g., a listener) who seeks to hear, or listen to, sounds/audio information within the person's surrounding environment, including speech/vocalized sounds emanating from one or more speaker(s) positioned in the surrounding environment. As shown, the hearing system 200 particularly includes a pair (e.g., one for each ear of a listener's head, such as each of the ears 114 of the listener's head 102 in FIG. 1) of combination input/output devices 202, in each of which can be implemented both one or more respective audio input device(s) 204 such as microphone(s) and one or more respective audio output device(s) 206 such as speaker(s). The combination input/output devices 202 can for example take the form of ear buds (or headphones) albeit, as described elsewhere herein, the present disclosure is intended to encompass a wide variety of hearing aids or other types of hearing systems other than those employing ear buds.

In addition to the combination input/output devices 202, the hearing system 200 additionally includes a computer system 210 that is coupled to the combination input/output devices 202, at least indirectly, as represented by dashed lines 208. The computer system 210 includes one or more processing device(s) 212 and one or more memory device(s) 214. The one or more processing device(s) 212 can include, for example, any one or more of microprocessor(s), controller(s), graphics processing units (GPUs), programmable logic devices (PLDs), application specific integrated circuits (ASICs), and/or other processing device(s). The processing device(s) 212 can be operated in accordance with various computer-executable instructions so as to perform any of a variety of different functions related to the performing of processing and taking of other actions as described herein. Also, the one or more memory device(s) 214 can include, for example, any one or more of random access memory (RAM) devices, read only memory (ROM) devices (and forms thereof, including electrically erasable programmable read only memory (EEPROM) devices), and/or other memory device(s). The memory device(s) 214 can store software, applications, or computer instructions in accordance with which one or more of the processing device(s) 212 operate. Further for example, in some embodiments, the computer system 210 can employ a device that has both processing and memory capabilities (e.g., a processor-in-memory or PIM).

Notwithstanding the manner in which the computer system 210 is illustrated figuratively in FIG. 2, it should be understood that the computer system 210 intended to be representative of any of a variety of embodiments of computer systems that can employ any of a variety of types of processing device(s) 212 or memory device(s) 214, including embodiments having multiple processing devices that are distributed or positioned at different locations, respectively, and/or embodiments having multiple memory devices that are distributed or positioned at different locations, respectively. Although the computer system 210 can for example be representative of a mobile device such as a cellular telephone, smart phone, or laptop or notebook computer, or of a desktop computer, the computer system 210 is also intended to be representative of a variety of distributed computer device(s) or combination systems such as, for example, a mobile device in communication with a cloud computing system that in turn includes numerous processing devices and memory devices that are respectively located at a variety of different respective locations. Communication among such numerous processing devices and memory devices, as well as between the computer system 210 and the combination input/output devices 202 (as represented by a dashed line 208) can occur in any of a variety of manners, such as by wired or wireless links or by the internet. Also, the present disclosure encompasses embodiments in which one or more processing device(s) and/or memory device(s) are positioned within the combination input/output devices 202 instead of, or in addition to, one or more computer systems that are distinct from those combination input/output devices such as the computer system 210.

As will be described in further detail below, in accordance with embodiments encompassed herein, the one or more memory device(s) 214 among other things can store one or more neural networks 216, and the one or more processing device(s) 212 among other things can perform instructions in relation to such one or more neural networks. Such instructions among other things can enable training of such one or more neural networks (e.g., during training mode) and also cause the one or more neural networks, as trained, to perform inferencing operations (e.g., during inference mode).

### Smart Speaker Selection Training System

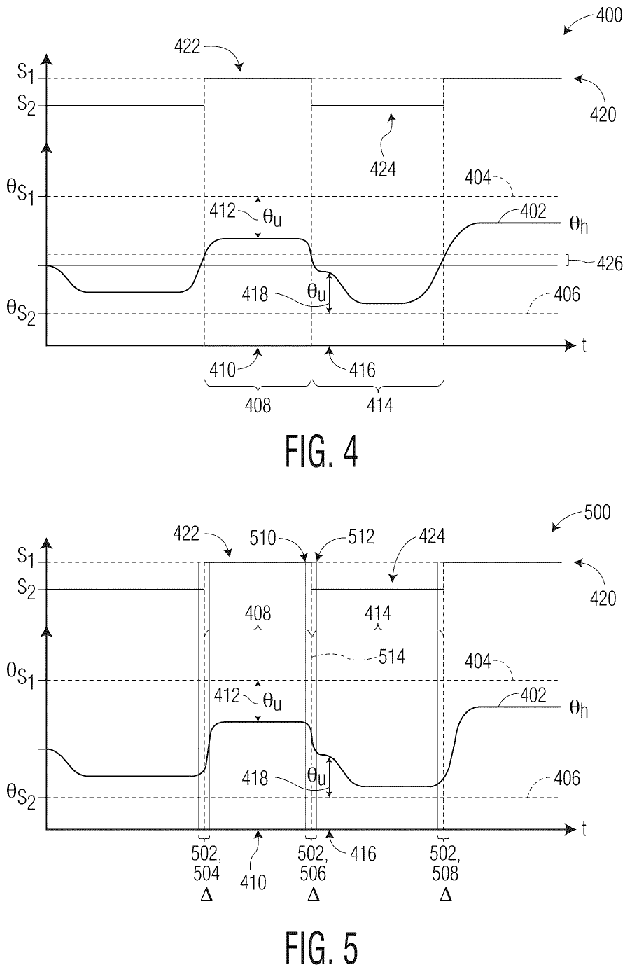

Referring next to FIG. 3, in at least some embodiments, the present disclosure relates to new or improved hearing systems or methods that employ a neural network, such as that represented by the hearing system 200 with the neural network 216 shown in FIG. 2, where the neural network has been trained in a manner illustrated by a schematic diagram 300. In general, this manner of training envisions a training system with multiple microphones that can be employed to train a neural network such that it will make the directivity of the microphone array optimal for listening through implicit beamforming. This is achieved by synchronizing, in training, the movement of the head of the listener with an undershot angle to the desired speaker direction, in a multi-speaker scenario, with desired clean speech used in the loss function. The neural network will learn, from the spatial information embedded in the multi-array audio, to optimally beamform towards the desired speaker. Most of the training samples should contain a nonzero undershot angle between the listener's head and the speaker's head, but the training data should also contain cases in which the listener is facing the desired speaker (the undershot angle is zero rather than nonzero), or in which there is only a single speaker.

More particularly as shown in FIG. 3, during training of the neural network, there are n microphones 302 within a real-world setup (or, alternatively, within a room simulation) 304 with n≥2, which can generate respective output signals 306 (y₁ . . . yₙ) that respectively capture the sound field at respective distinct (different) places within the real-world setup. The n microphones 302 within the real-world setup 304 receive sound from the environment in which they are located, as defined by several input parameters 308 (here abstracted as parameters for easier comprehension and simpler relation to a simulated environment), including clean speech data 310, noise data 312, room characteristics data 314, speakers/listener characteristics data 316, and listener random head angle data 318. The listener random head angle data 318 can be undershot angle (θu) data as described elsewhere herein. Although FIG. 3 happens to illustrate that the n microphones 302 includes two microphones, as represented by an ellipsis 340 there can be any arbitrary number of microphones (typically two or more microphones) depending upon the embodiment or setup.

Additionally in the real-world setup 304, a first one 320 of the n microphones 302 (e.g., the microphone providing output signal y₁) is close to (or in) one ear (e.g., one of the ears 114 of the listener's head 102 from FIG. 1). Other one(s) of the n microphones 302 of the real-world setup 304, such as a first other one 322 of the n microphones 302 shown in FIG. 3, can have locations that are elsewhere. For example, such other one(s) of the n microphones can be located even at a remote station such as a smart phone (or other phone or mobile device), or at a dedicated device containing one or more microphones, or at the location of a (human) speaker, or in the vicinity of those ones of the microphones 302 that generate the output signals y₁ or y₂ (the latter of which, for example, can be positioned, for example, at the other ear, e.g., of the listener's head 102). The microphones' output signals 306 (y₁ . . . yₙ) are provided to a deep neural network 324 that is undergoing training and, in this sense, the output signals 306 (y₁ . . . yₙ) also can be considered input signals. The deep neural network 324 for example can correspond to the neural network 216 shown to be stored in the memory device(s) 214 of FIG. 2, and training of the neural network 216 can be performed through operation of the processing device(s) 212 of FIG. 2. The microphones 302 may be coupled in a wired or wireless manner with respect to the processing device(s) (e.g., the processing device(s) 212) and work together as a beamformer. Preferably, the latency of any wireless connection is low with respect to the latency caused by the signal processing of the processing device(s).

In response to the receiving the output signals 306 (y₁ . . . yₙ), the deep neural network 324 (which is undergoing training) outputs m output signals 326 (z₁ . . . zₘ), which can be coefficients of a filter, tensors with statistical quantities, multi-channel representation of clean speech or correspond to output signals from (for example) the output speakers of a wearable device. The m output signals 326 (z₁ . . . zₘ) are provided for receipt by a loss processing block 328. Also during training, an additional processing block 330 determines and outputs desired speaker clean speech data, as represented by an arrow 332. The desired speaker clean speech data 332 is determined at the additional processing block 330 (but could also be embedded into the setup/simulation 304) based upon the listener random head angle data 318 (which again can be undershot angle (θᵤ) data) as represented by an arrow 334, and additionally based upon a combination of portions of the clean speech data 310 and position data (randomly defined), as represented by an arrow 336. (The additional processing block 330 can also be considered to represent operation(s) that allow for the closest speaker to the listener's center axis to be found or identified during training, since such information is available.) As shown by the arrow 332, the desired speaker clean speech data (which can also be referred to as the clean speech of the desired speaker 1 (θᵤ)) output by the additional processing block 330 is also provided to the loss processing block 328 during training of the deep neural network 324, along with the m output signals 326 (z₁ . . . zₘ). In response to receiving the desired speaker clean speech data and the m output signals 326, the loss processing block 328 generates weight update signals represented by an arrow 338, which are provided back to the deep neural network 324 to further train the deep neural network.

It should be appreciated that, during the training phase, there are speech fragments from various directions to the listener. There can be one speaker at a time, or multiple speakers at the same time. The speakers can be facing the listener L (e.g., as shown in FIG. 1) or can be looking to the listener with an undershot angle, without facing the subject directly. The speech fragments may be utterances with and without face mask of different voices, including various male and female speakers. If there is more than one speaker at the same time, then one of those speakers will be designated as the desired speaker at that time-more particularly, the speaker having a respective location relative to the listener that has the smaller (or smallest) angular difference in relation to the center axis of the listener will be chosen to be the desired speaker (target) at that time. However, if the listener moves such that the undershot angle relationship changes, the desired speaker can also be changed. Or, if one or more of the speakers change, in terms of their positions relative to the listener, or in terms of who is speaking at any given time (again such that the undershot angle relationship changes), the desired speaker can also again be changed. Also, the acoustic signals during training can be contaminated by noise, reverberation/reflections, etc. Further, it should be appreciated that, during training, the corresponding clean speech (clean speech of the desired speaker 1 (θᵤ)) is used for the loss calculation during training (via l to the neural network). Ultimately, based upon the training, the neural network (e.g., the deep neural network 324 of FIG. 3, which can be the neural network 216 stored in the memory device(s) 214 and performed by the processing device(s) 212 of FIG. 1) is optimized such that the output signals resemble the desired clean speech signals, but it could also output coefficients or statistics of a given filter. Moreover, the neural network 324 could be used to estimate solely one or more angles of the current simulation/real-world setup (e.g., angle θᵤ from FIG. 1), information that could be used for the training of another neural network or processing via a beamforming filter.

It should be appreciated that, during training, it is possible to employ “artificial heads” as the listener's head and each of the speakers' heads, for example, by positioning artificial speakers at the locations of the speaker's heads and a microphone at the listener's head location. Different ones of the speakers' heads can be caused to utter different sounds at various times, including various times at which the listener's head may be at different locations or have different orientations. For example, with reference to FIG. 1 and at a first time, a first artificial head can be positioned as the listener's head 102 pertaining to the listener L, and second and third artificial heads can respectively positioned as the first speaker's head 106 and the second speaker's head 108 pertaining to the speakers S₁ and S₂, respectively. Additionally, pre-recorded clean speech can be rendered via the artificial mouth of one of the speaker's heads that is designated as the desired speaker (e.g., the first speaker's head 106, for speaker S₁ as shown in FIG. 1), and the clean speech l at the same time can be fed (e.g., as represented by the arrow 332) to the loss processing block 328 (and thus to the neural network), to be used for loss calculation. The other speaker head(s), which are designated as not being the desired speaker (e.g., the second speaker's head 108, for speaker S₂ as shown in FIG. 1), still may render other speech or noise. Because of the reverberation in the room (e.g., as represented by the arrow 128 in FIG. 1) and the other speaker head(s), the desired speech signals received by the microphones will be contaminated by reverberation and noise.

Additionally for example, in a different part of the training and at a second time, pre-recorded clean speech can instead be rendered via the artificial mouth of a different one of the speaker's heads that is designated as the desired speaker at that second time (e.g., the second speaker's head 108, for speaker S₂ as shown in FIG. 1, such that the desired speech is now uttered by S₂). The shift in the desired speaker designation to the different one of the speaker's heads can be triggered by a changed head positioning and consequent different head angle (e.g., a change in θₕ) of the listener's head. With this change, the corresponding clean speech signal (e.g., as represented by the arrow 332) is fed to the loss processing block 328 (and thus to the neural network) for loss calculation. This process can additionally be repeated, during training, for a variety of different speaker's heads (not merely the two speaker's heads shown in FIG. 1), various positions or directional orientations of those speaker's heads, and various locations or angular orientations of the listener's head. Based upon the information generated from such training efforts, the neural network (e.g., the neural network 324) now learns to choose the desired speaker-based on the head angle information embedded in the phase- and learns to process the microphone signals such that the output is close to the desired clean speech signal.

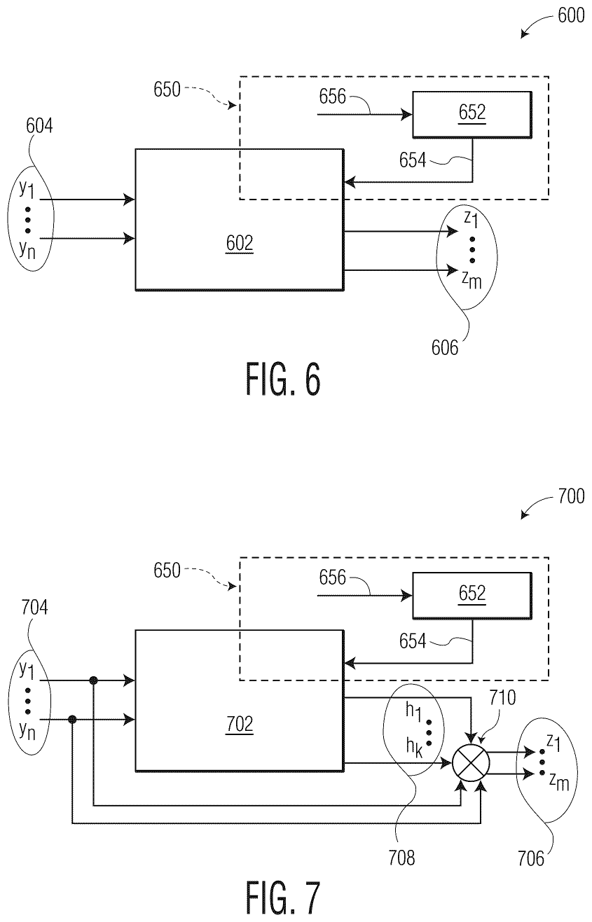

Referring now to FIG. 4 and FIG. 5, respectively, a first timing diagram 400 and a second timing diagram 500, respectively, illustrate a first example training routine and a second example training routine, respectively, for the deep neural network 324. The first example training routine shown in the first timing diagram 400 of FIG. 4 is a training routine in which the desired speaker is changed according to the undershot angle (or head angle). By comparison, the second example training routine shown in the second timing diagram 500 of FIG. 5 is a training routine in which the desired speaker is changed according to a variation (Δ) of the undershot angle θᵤ (or head angle). Both of the first timing diagram 400 and the second timing diagram 500 illustrate example manners of operation for arrangements/circumstances in which there is a listener (L) and first and second speakers (S₁ and S₂) consistent with the example scenario shown in FIG. 1. Nevertheless, it should be appreciated that the first timing diagram 400 and second timing diagram 500 are merely examples and that the present disclosure envisions many other scenarios in which there are more than two speakers, for which different timing diagrams would be appropriate. Further, it is worth mentioning that the undershot angle is not explicitly provided at the input of the neural network model during training, since this information is embedded in the phase relation between multi-array inputs.

More particularly with respect to FIG. 4, the first timing diagram 400 includes a first curve 402, a second curve 404, and a third curve 406 that respectively show example angular positional variation over time (t) of the listener center axis 110, the first axis 120, and the second axis 122, respectively. In the first timing diagram 400, for each of the first curve 402, the second curve 404, and the third curve 406, time (t) variation occurs along the x-axis and angular position variation occurs along the y-axis. More particularly, the first curve 402 shows angular positional variation of the listener center axis 110, that is, variation of the angle θₕ (again, as shown in FIG. 1, the axis extending forward of listener's head), relative to time (t). Additionally, the second curve 404 and a third curve 406 respectively show that each of the first axis 120 and the second axis 122, respectively, corresponding to the angular positional orientations of the first head and second head 106 and 108, respectively (of the first speaker (S₁) and the second speaker (S₂), respectively), have angular positions, that is, namely, θₛ_{₁} and θₛ_{₂}, respectively, which are constant in position.

From FIG. 1, it should be appreciated that the undershot angle (angle θᵤ) can be seen as constituting the difference, at any given time, between the first curve 402 and either of the second curve 404 or the third curve 406. Whether the undershot angle constitutes the difference between the first curve 402 and the second curve, or the difference between the first curve and the third curve 406, depends upon whether the angular difference between the first curve 402 and the second curve is larger or smaller than the difference between the first curve and the third curve. This is because, as defined herein, the undershot angle is understood to be that one of the angular differences between the listener center axis and the respective axes extending between the listener's head and the various respective speakers that is the smallest angular difference (or the smaller angular difference, in this example in which there are only two speakers). Given this to be the case, it can be seen that, for example during a first time period 408, the first curve 402 representing the angular position of the listener center axis 110 is closer to the second curve 404 than the third curve 406. Thus, for example, at a first time 410, a first value 412 of the undershot angle θᵤ corresponds to the difference between the first curve 402 and the second curve 404 at that first time. However, also for example during a second time period 414, the first curve 402 representing the angular position of the listener center axis 110 is closer to the third curve 406 than the third curve 404. Thus, for example, at a second time 416, a second value 418 of the undershot angle θᵤ corresponds to the difference between the first curve 402 and the third curve 406 at that first time.

In addition, a fourth curve 420 in FIG. 4, further illustrates how, as the relative position of the listener center axis 110 as represented by the first curve 402 varies relative to each of the first axis 120 and the second axis 122 as represented by the second curve 404 and the third curve 406, respectively, the desired speaker changes between the first speaker (S₁) and the second speaker (S₂) based upon whether the undershot angle is determined as being between the first and second curve or between the first and third curves. More particularly, as shown, during time periods such as the first time period 408 when the first curve 402 is closer to the second curve 404 than to the third curve 406, such that the undershot angle θᵤ is between those two curves, then the desired speaker is the first speaker (S₁) corresponding to the first axis 120 (and the first speaker head 106 of FIG. 1), as shown by a first segment 422 of the fourth curve 420. Alternatively as shown, during time periods such as the second time period 414 when the first curve 402 is closer to the third curve 406 than to the second curve 404, such that the undershot angle θᵤ is between those two curves, then the desired speaker is the second speaker (S₂) corresponding to the second axis 122 (and the second speaker head 108 of FIG. 1), as shown by a second segment 424 of the fourth curve 420.

The manner in which variations in the first curve 402 relative to the second curve 404 and the third curve 406 can trigger variations in the undershot angle θᵤ, particularly in terms of the determination of the undershot angle θᵤ as being measured between the listener center axis 110 and the first axis 120 or between the listener center axis 110 and the second axis 122 (or between the listener center axis 110 and any other axis associate with any other speaker) and consequent determination of the desired speaker, can vary depending upon the embodiment. Further for example, in at least some embodiments, to avoid rapid, repeated switches back and forth between or among different speakers when there are multiple speaker having locations that are similarly situated relative to the listener center axis, switching from one speaker (e.g., from the first speaker S₁) to another speaker (e.g., to the second speaker S₂) as the desired speaker need not necessarily occur immediately when the angular difference between the listener center axis 110 and that other speaker's axis (e.g., the second axis 122) becomes smaller than the angular difference between the listener center axis 110 and the one speaker's axis (e.g., the first axis 120). Rather, as illustrated by a threshold 426 in FIG. 4, in at least some embodiments or implementations, the desired speaker is only switched from a current desired speaker to a new desired speaker after the angular difference between the listener center axis and the axis associated with the new desired speaker decreases below the angular difference between the listener center axis and the axis associated with the current desired speaker by a threshold amount 426.

Further with respect to FIG. 5, the second diagram 500 again includes each of the first curve 402, the second curve 404, the third curve 406, and the fourth curve 420. Also, in the second diagram 500 as illustrated, the angular positional variation over time (t) of the listener center axis 110 relative to the first axis 120 and the second axis 122, respectively, and corresponding variations in the undershot angle θᵤ (including the values of the undershot angle at the first time 410 and the second time 416) are the same as shown in FIG. 4. Also, the variations in the desired speaker between being the first speaker (S₁) and the second speaker (S₂) are the same as shown in FIG. 4, with for example the desired speaker being the first speaker (S₁) during the first time period 408, and the desired speaker being the second speaker (S₂) during the second time period 414.

Notwithstanding the above-described similarities between FIG. 5 and FIG. 4, FIG. 5 differs from FIG. 4 in that it illustrates an alternative manner of operation in terms of how variations in the first curve 402 relative to the second curve 404 and the third curve 406 can trigger variations in the determination of the undershot angle θᵤ and consequent variations in the determination of the desired speaker. More particularly, in this embodiment, it can be seen that variations (Δ) of the undershot angle θᵤ (or head angle) over particular time intervals (delta or A time intervals) 502 are tracked. FIG. 5 particularly illustrates three of the time intervals 502, shown as first, second, and third ones 504, 506, and 508, respectively, of the time intervals.

As illustrated, each of the time intervals 502 begins when the undershot angle θᵤ begins to increase from minimal value. For example, the second one 506 of the time intervals 502, begins at a start time 510 at which the undershot angle θᵤ is beginning to increase from the value 412 that was present at the first time 410 and was recently the minimal value of the undershot angle θᵤ. Upon commencing at the start time 510, the second one 506 of the time intervals 502 continues to up until a completion time 512, with a midpoint time 514 occurring midway between the start time 510 and the completion time 512. Further, at the midpoint time 514, the undershot angle θᵤ changes from being determined as the difference between the first curve 402 (the listener center axis 110) and the second curve 404 (the first axis 120) to being determined as the difference between the first curve 402 and the third curve 406 (the second axis 122). Likewise, the midpoint time 514 also is the time at which the desired speaker changes from being the first speaker (S₁), as is the case within the first segment 422, to being the second speaker (S₂), as is the case within the second segment 424.

Correspondingly, with respect to each of the first one 504 and third one 508 of the time intervals 502, it can be seen that each of those time intervals includes a respective start time that begins when a current undershot angle θᵤ begin to increase from a recent local minimum level, as well as respective completion time and a respective midpoint time. Again, with respect to each of the first one 504 and the third one 508 of the time intervals 502, it is at the respective midpoint time within each time interval that the undershot angle changes from being determined as the difference between the first curve 402 and the third curve 406 to being determined as the difference between the first curve and the second curve 404, and correspondingly the desired speaker changes from being the second speaker (S₂) to being the first speaker (S₁). Notwithstanding the above description, the present disclosure envisions additional manners of determining undershot angles and desired speakers, including different manners suitable for different contexts and/or different numbers of speakers.

Upon a neural network such as the deep neural network 324 being trained as described above, an improved hearing system such as the improved hearing system 200 of FIG. 2 can be operated in an inference mode of operation. During the inference mode of operation, the improved hearing system 200 can employ the neural network 216, which again can be the deep neural network 324 as trained, to generate sound outputs that particularly reflect, at any given time, the sounds emitted by (e.g., words or vocalized expressions of) a desired speaker. Whether the sounds emitted by any given speaker from among two or more speakers in the vicinity of the improved hearing system 200 (and any listener wearing that improved hearing system) constitute the sounds of a desired speaker is determined, based upon the neural network 324 in accordance with its training.

In at least some embodiments encompassed herein, during the inference mode of operation, one or more processing device(s) of an improved hearing system such as the improved hearing system 200 (e.g., the processing device(s) 212) operate in accordance with a trained neural network such as the neural network 216 to generate output signals (or intermediate signals based upon which output signals can further be generated) that, to a higher degree than in the overall audio information that may be received via audio input device(s) such as the audio input device(s) 204, reflect or emphasize at least one desired sound source component of the audio information arising from a desired one of the sound sources from among multiple sound sources (e.g., from a desired human speaker from among a plurality of human speakers who are speaking). The trained neural network determines the desired one of the sound sources (and thereby the desired sound source component) at least indirectly based upon a first undershot angle evident from the audio information.

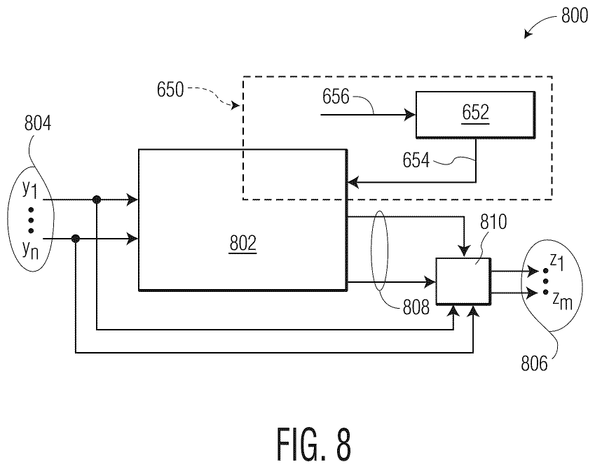

The present disclosure envisions numerous different embodiments of improved hearing systems employing numerous particular forms of neural networks that operate in inference modes generally as described above. FIG. 6, FIG. 7, and FIG. 8 respectively provide first, second, and third additional schematic diagrams, respectively, which illustrate first, second, and third example embodiments of improved hearing systems shown as improved hearing systems 600, 700, and 800, respectively. Each of the first, second, and third improved hearing systems 600, 700, and 800 corresponds to, and can be considered to constitute a different embodiment (or version or implementation of), the improved hearing system 200 of FIG. 2. More particularly as shown, the first, second, and third improved hearing systems 600, 700, and 800 respectively include first, second, and third trained deep neural network 602, 702, and 802, respectively, each of which corresponds to, and can be considered to constitute a different embodiment (or version or implementation of), the neural network 216 of FIG. 2.

Each of the first, second, and third trained deep neural networks 602, 702, and 802 is figuratively illustrated in FIG. 6, FIG. 7, and FIG. 8, respectively, as having been trained, as represented by a training block shown in dashed lines 650. As illustrated figuratively, the training of each of the first, second, and third trained deep neural networks 602, 702, and 802 particularly involves training, as represented by a desired speaker choice block 652, that enables the respective deep neural network to determine a desired speaker choice (1) as represented by an arrow 654. As further represented by an arrow 656, such determinations by the desired speaker choice block 652 are based upon head angle or variations (Δ) of head angle information, which as described above constitutes angular information upon which determinations of an undershot angle and corresponding desired speaker can be made by the respective deep neural network.

Additionally, each of the first, second, and third improved hearing systems 600, 700, and 800 is shown particularly to receive respective input signals 604, 704, and 804, which can be considered speech or other sound information signals received from respective microphones/sound sensors such as respective ones of the audio input devices 204 of the combination input/output devices 202 of FIG. 2. The respective input signals 604, 704, and 804 can be considered to be analogous to the output signals 306 (y₁ . . . yₙ) described above in regard to the training of the deep neural network 324, insofar as the respective input signals 604, 704, and 804 are input into the respective deep neural networks 602, 702, and 802. In contrast to FIG. 3, which shows the deep neural network 324 when undergoing training in training mode, FIG. 6, FIG. 7, and FIG. 8 are intended to represent the first, second, and third improved hearing systems 600, 700, and 800 during an inference mode of operation rather than a training mode of operation. However, if the simplified training (dashed) block 650 from hearing systems 600, 700, and 800 is removed, then FIG. 6, FIG. 7, and FIG. 8 may represent the deep neural network block 324 in more detail, as inputs 306 and outputs 326 can be directly mapped to inputs 604 and outputs 606, inputs 704 and outputs 706, and inputs 804 and outputs 806, respectively.

Further as shown in FIG. 6, FIG. 7, and FIG. 8, the first, second and third improved hearing systems, based upon the received respective input signals 604, 704, and 804, generate respective output signals 606, 706, and 806 (z₁ . . . zₘ). The respective output signals 606, 706, and 806 can respectively constitute the audio information or signals output by respective speakers/sound output devices of the respective first, second, and third improved hearing systems 600, 700, and 800, such as the respective output speakers 206 of the combination input/output devices 202 of FIG. 2. As will be described in further detail below, although each of the first, second, and third improved hearing systems 600, 700, and 800 generates the respective output signals 606, 706, and 806 based upon the received respective input signals 604, 704, and 704, via respective operations of the first, second, and third trained deep neural network 602, 702, and 802, respectively, each of the first, second, and third improved hearing systems 600, 700, and 800 operates in a respective different manner.

### End-to-End Neural Network

More particularly with respect to FIG. 6, the first improved hearing system 600 is an end-to-end neural network implementation. In this embodiment, the first trained deep neural network 602 is an end-to-end neural network that estimates directly the desired clean speech signal. In this embodiment the signal represented by the arrow 654 is a desired speaker choice (1) that represents the clean speech fed to the neural network during training and is not part of the system during the inference mode of operation. As mentioned above, the respective output signals 606 (e.g., m output signals z₁ . . . zₘ) can be the audio information or signals output by respective speakers/sound output devices of the respective first improved hearing system 600, such as the respective output speakers 206 of the combination input/output devices 202 of FIG. 2 (e.g., different speakers of hearing aid(s)). In this embodiment, the choice of desired speaker is done based on either the head angle information or the variation (A) of the head angle-indirectly extracted by the first trained deep neural network 602 with the information embedded in the respective input (audio) signals 604 (y₁· . . . yₙ).

In this embodiment, an example of a loss function considering the simpler case with a single output z₁, is shown in Equation (2):

$${ℒ}_{1} ( w ) = {arg}_{w} min loss\_fn ( {z}_{1} , l ( {θ}_{u} ) ) , \qquad ( 2 )$$

where z₁ is the clean speech estimated by the neural network with weights w, l(θᵤ) is the clean speech of the desired speaker dependent on the angle between the listener center axis and the speaker's angle of arrival (the undershot angle θᵤ), and loss_fn is any chosen loss function, e.g., a multi-resolution spectrogram loss or more specific metrics, such as the Hearing-Aid Speech Quality Index (HASQI). For better performance, mainly in terms of denoising, the loss function also take phase into account.

### Neural Network-Estimation of a Linear Filter

Additionally with respect to FIG. 7, the second improved hearing system 700 is an implementation in which there is neural network estimation of a linear filter. In this embodiment, the second trained deep neural network 702, based upon the respective input signals 704 (y₁ . . . yₙ), estimates and outputs k coefficients (or parameters) 708 (h₁ . . . hₖ) of a linear filter used for beamforming. Further as shown, the respective input (audio) signals 704 (y₁ . . . yₙ), which are noisy, are multiplied by the coefficients 708 of the linear filter in the frequency domain (or convolved in time domain) as represented by a multiplication block 710. Such operation at the multiplication block 710 results in the respective output signals 706 (e.g., m output signals z₁ . . . zₘ), which can be the audio information or signals output by respective speakers/sound output devices of the respective first improved hearing system 600, such as the respective output speakers 206 of the combination input/output devices 202 of FIG. 2 (e.g., different speakers of hearing aid(s)). More particularly, such operation at the multiplication block 710 results in the respective output signals 706 (z₁ . . . zₘ) that constitute the desired clean speech output. Again, with respect to the embodiment of FIG. 7, the concept of changing the desired speaker during training is also considered in this case.

For the system of FIG. 7 considering only one output z₁, the loss function of Equation (2) can be modified to take the form of Equation (3):

$${ℒ}_{2} ( w ) = {arg}_{w} min loss\_fn ( hy , l ( {θ}_{u} ) ) , \qquad ( 3 )$$

in which h=h₁ . . . hₖ and y=y₁ . . . yₙ, and hy=z₁.

### Neural Network-Estimation of Statistics of a Filter

Further with respect to FIG. 8, the third improved hearing system 800 is an implementation in which there is neural network estimation of statistics of a filter. That is, in the third improved hearing system 800, the third trained deep neural network 802, based upon the respective input signals 804 (y₁· . . . yₙ), estimates and outputs statistics 808 of a minimum variance distortionless response (MVDR) filter 810. Also as shown, both the statistics 808, and also the respective input signals 804 (y₁ . . . yₙ) are provided to the MVDR filter 810. Operation of the MVDR filter in turn results in the respective output signals 806 (e.g., m output signals z₁ . . . zₘ), which can be the audio information or signals output by respective speakers/sound output devices of the respective third improved hearing system 800, such as the respective output speakers 206 of the combination input/output devices 202 of FIG. 2 (e.g., different speakers of hearing aid(s)). More particularly, such operation at the MVDR filter 810 results in the respective output signals 806 (z₁ . . . zₘ) that constitute the constitute the desired clean speech output. Again, with respect to the embodiment of FIG. 8, the concept of changing the desired speaker during training is also considered in this case.

With respect to the third improved hearing system 800 a possible loss function when only z₁ is an output can be as shown in Equation (4):

$${ℒ}_{3} ( w ) = {arg}_{w} min loss\_fn ( {h}_{M V D R} ( \hat{v} , {\hat{Φ}}_{N}^{- 1} ) y , l ( {θ}_{u} ) ) , \qquad ( 4 )$$

with the MVDR coefficients h_{MVDR} being dependent on the neural network-estimated directivity array \hat{v} and noise correlation inverse matrix

$${\hat{Φ}}_{N}^{- 1} ,$$

and h_{MVDR}y=z₁.

The third improved hearing system 800 is representative of a variety of embodiments that operate by performing neural network estimation of statistics of a filter. Although FIG. 8 shows the third improved hearing system 800 as employing an MVDR filter, the present disclosure also encompasses embodiments in which other filters are employed and in which statistics such as the statistics 808 are estimated (or generated) or provided for such other filters, including a variety of other known filters. Indeed, the third improved hearing system 800 can be used to extend the performance of known, reliable, and stable filter structures.

The present disclosure encompasses numerous embodiments and variations of embodiments in addition to those described above, including both a variety of different systems as well as a variety of different methods of operation and implementation, including methods involving training mode operation, inference mode operation, and combinations of both training mode and inference mode operation. For example, the respective input signals 604, 704, and 804 in FIG. 6, FIG. 7, and FIG. 8, respectively, as well as the output signals 306 in FIG. 3 (y₁ . . . yₙ, in each of FIG. 6, FIG. 7, FIG. 8, and FIG. 3) can be used directly as the microphones' outputs, but it these also be pre-processed version(s) of such outputs. A common approach would be to calculate the short-term Fourier transform (STFT) of each microphone output and concatenate its real part with imaginary part. Other types of filtering can also be applied. Additionally, multiple input features originated from the microphones' outputs can be combined, e.g., a concatenation of the STFTs of the outputs with their generalized cross-correlation with phase transform (GCC-PHAT), obtained at each microphone pair.

Further, in at least some embodiments encompassed herein, the present disclosure relates to a hearing system comprising one or more memory devices configured to store a first neural network, one or more audio input devices configured to receive audio input signals including audio information arising from a plurality of sound sources, one or more audio output devices, and one or more processing devices coupled at least indirectly to the one or more memory devices, the one or more audio input devices, and the one or more audio output devices. During an inference mode, the one or more processing devices are configured to operate in accordance with the first neural network to generate intermediate output signals that, to a higher degree than in the audio information, reflect or emphasize at least one desired sound source component of the audio information arising from a desired one of the sound sources of the plurality of sound sources determined to be the desired one of the sound sources at least indirectly based upon a first undershot angle evident from the audio information. The one or more audio output devices are configured to generate audio output signals based at least indirectly upon the intermediate output signals.

In at least some such embodiments, the one or more audio input devices includes one or more microphones, the one or more audio output devices include one or more speakers, the one or more processing devices include at least one microprocessor or graphics processing unit (GPU), and the first neural network is a deep neural network. Also, in at least some such embodiments, the hearing system is a hearing aid system. Further, in at least some such embodiments, the audio input devices are positioned on or associated with a listener human being having a listener center axis extending therefrom, the plurality of sound sources includes a plurality of sound source human beings, and the desired one of the sound sources is a first one of the sound source human beings. Also, in at least some such embodiments, a plurality of additional axes extend respectively between the respective sound source human beings and the listener human being, a plurality of angular differences exist respectively between the listener center axis and the respective additional axes of the plurality of additional axes, and the first undershot angle is a first angular difference between the listener center axis and a first one of the additional axes that, at a first time, is smaller than each other one of the angular differences.

Further, in at least some such embodiments, the one or more processing devices are further configured to operate to determine a second undershot angle that is different from the first undershot angle, the second undershot angle is a second angular difference between the listener center axis and a second one of the additional axes that, at a second time, becomes smaller than the first angular difference, and, at or substantially at the second time, a switching of the desired one of the sound sources switches from being the first one of the sound source human beings to being a second one of the sound source human beings associated with the second one of the additional axes. Also, in at least some such embodiments, the intermediate output signals are linear filter coefficients, and the one or more processing devices are further configured to operate to multiply or convolve the linear filter coefficients with the audio input signals or additional signals based at least indirectly upon the audio input signals to generate further intermediate output signals, where the audio output signals are based at least indirectly upon the further intermediate output signals. Additionally, in at least some such embodiments, the intermediate output signals are statistics for a filter, and the one or more processing devices are further configured to operate to process, by the filter with respect to which the statistics pertain, the statistics and the audio input signals or additional signals based at least indirectly upon the audio input signals to generate further intermediate output signals, where the audio output signals are based at least indirectly upon the further intermediate output signals. Also, in at least some such embodiments, the filter is a beamforming filter that is minimum variance distortionless response (MVDR) filter.

Additionally, in at least some example embodiments, the present disclosure relates to a method of training a first neural network for use in a hearing system. The method includes providing one or more audio input devices within a region in which are positioned a plurality of sound sources, and receiving input signals at the one or more audio input devices, the input signals including undershot angle data as described elsewhere herein. Additionally, the method includes providing either the input signals, or intermediate signals based upon the input signals, to the first neural network, and generating by the first neural network a plurality of output signals. Also, the method includes processing the output signals, along with desired speaker clean speech data determined at least in part based upon the undershot angle data, at a loss processing block, to determine a plurality of weight signals, and updating the first neural network based upon the weight signals.

In at least some such embodiments, the receiving, providing, generating, processing, and updating are repeated until the training of the first neural network is complete, and the first neural network is a deep neural network. Also, in at least some such embodiments, the one or more audio input devices include a plurality of microphones within a room simulation, the respective microphones being situated to respectively capture a sound field at respective different locations, and the audio input signals received by the one or more audio input devices include clean speech data, noise data, room characteristics data, speakers/listener characteristics data, and listener random head angle data that includes the undershot angle data.

Additionally, in at least some example embodiments, the present disclosure relates to a method of operating, during an inference mode, a hearing system including one or more memory devices configured to store a first neural network. The method includes receiving audio input signals at one or more audio input devices, the audio input signals including audio information arising from a plurality of sound sources. Also, the method includes operating one or more processing devices in accordance with the first neural network to generate intermediate output signals that, to a higher degree than in the audio information, reflect or emphasize at least one desired sound source component of the audio information arising from a desired one of the sound sources of the plurality of sound sources determined to be the desired one of the sound sources at least indirectly based upon a first undershot angle evident from the audio information. Further, the method includes generating, at one or more audio output devices, audio output signals based at least indirectly upon the intermediate output signals.

In at least some such embodiments, the audio input devices are positioned on or associated with a listener human being having a listener center axis extending therefrom, the plurality of sound sources includes a plurality of sound source human beings, and the desired one of the sound sources is a first one of the sound source human beings. Also, in at least some such embodiments, a plurality of additional axes extend respectively between the respective sound source human beings and the listener human being, a plurality of angular differences exist respectively between the listener center axis and the respective additional axes of the plurality of additional axes, and the first undershot angle is a first angular difference between the listener center axis and a first one of the additional axes that, at a first time, is smaller than each other one of the angular differences. Further, in at least some such embodiments, the operating includes determining a second undershot angle that is different from the first undershot angle, the second undershot angle is a second angular difference between the listener center axis and a second one of the additional axes that, at a second time, becomes smaller than the first angular difference, and, at or substantially at the second time, a switching of the desired one of the sound sources switches from being the first one of the sound source human beings to being a second one of the sound source human beings associated with the second one of the additional axes.

Additionally, in at least some such embodiments, the intermediate output signals are linear filter coefficients, and the method further includes multiplying or convolving the linear filter coefficients with the audio input signals or additional signals based at least indirectly upon the audio input signals to generate further intermediate output signals, where the audio output signals are based at least indirectly upon the further intermediate output signals. Also, in at least some such embodiments, the intermediate output signals are statistics for a filter, and method further includes processing, by the filter with respect to which the statistics pertain, the statistics and the audio input signals or additional signals based at least indirectly upon the audio input signals to generate further intermediate output signals, where the audio output signals are based at least indirectly upon the further intermediate output signals. Further, in at least some such embodiments, the filter is a beamforming filter that is minimum variance distortionless response (MVDR) filter. Also, in at least some such embodiments, the first neural network is a deep neural network that was trained prior to operating in the inference mode, so as to be able to identify undershot angles and respective desired sound sources based upon received audio data.

The present disclosure encompasses numerous embodiments that, depending upon the embodiment, can be advantageous in one or more respects. In at least some embodiments of improved hearing systems and methods encompassed herein, the improved hearing systems and methods (1) employ a smart speaker selection mechanism for training, and (2) consider an undershot angle. With this approach, one can obtain optimal spatial beamforming without any prior knowledge on number of speakers, on their individual positions, and no necessity for self-supervised (also referred to as unsupervised) or reinforcement learning, in the presence of noise and reverberation, and yet with an undershot angle between listener center axis and speaker. Although a significant application of the embodiments described herein is hearing aids-related products (e.g., chips for such devices), the present disclosure also encompasses numerous other applications. For example, some such secondary applications can include other wearables like earbuds or headphones, as well as other applications including teleconferencing applications, public address systems, and other applications.

While the principles of the invention have been described above in connection with specific apparatus, it is to be clearly understood that this description is made only by way of example and not as a limitation on the scope of the invention. It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A hearing system comprising:
one or more memory devices configured to store a first neural network;
one or more audio input devices configured to receive audio input signals including audio information arising from a plurality of sound sources;
one or more audio output devices; and
one or more processing devices coupled at least indirectly to the one or more memory devices, the one or more audio input devices, and the one or more audio output devices,
wherein, during an inference mode, the one or more processing devices are configured to operate in accordance with the first neural network to generate intermediate output signals that, to a higher degree than in the audio information, reflect or emphasize at least one desired sound source component of the audio information arising from a desired one of the sound sources of the plurality of sound sources determined to be the desired one of the sound sources at least indirectly based upon a first undershot angle evident from the audio information, and
wherein the one or more audio output devices are configured to generate audio output signals based at least indirectly upon the intermediate output signals.

2. The hearing system of claim 1, wherein the one or more audio input devices includes one or more microphones, wherein the one or more audio output devices include one or more speakers, wherein the one or more processing devices include at least one microprocessor or graphics processing unit (GPU), and wherein the first neural network is a deep neural network.

3. The hearing system of claim 2, wherein the hearing system is a hearing aid system.

4. The hearing system of claim 1, wherein the audio input devices are positioned on or associated with a listener human being having a listener center axis extending therefrom, wherein the plurality of sound sources includes a plurality of sound source human beings, and wherein the desired one of the sound sources is a first one of the sound source human beings.

5. The hearing system of claim 4, wherein a plurality of additional axes extend respectively between the respective sound source human beings and the listener human being, wherein a plurality of angular differences exist respectively between the listener center axis and the respective additional axes of the plurality of additional axes, and wherein the first undershot angle is a first angular difference between the listener center axis and a first one of the additional axes that, at a first time, is smaller than each other one of the angular differences.

6. The hearing system of claim 5,
wherein the one or more processing devices are further configured to operate to determine a second undershot angle that is different from the first undershot angle, wherein the second undershot angle is a second angular difference between the listener center axis and a second one of the additional axes that, at a second time, becomes smaller than the first angular difference, and
wherein, at or substantially at the second time, a switching of the desired one of the sound sources switches from being the first one of the sound source human beings to being a second one of the sound source human beings associated with the second one of the additional axes.

7. The hearing system of claim 1, wherein the intermediate output signals are linear filter coefficients, and wherein the one or more processing devices are further configured to operate to multiply or convolve the linear filter coefficients with the audio input signals or additional signals based at least indirectly upon the audio input signals to generate further intermediate output signals, wherein the audio output signals are based at least indirectly upon the further intermediate output signals.

8. The hearing system of claim 1, wherein the intermediate output signals are statistics for a filter, and wherein the one or more processing devices are further configured to operate to process, by the filter with respect to which the statistics pertain, the statistics and the audio input signals or additional signals based at least indirectly upon the audio input signals to generate further intermediate output signals, wherein the audio output signals are based at least indirectly upon the further intermediate output signals.

9. The hearing system of claim 8, wherein the filter is a beamforming filter that is minimum variance distortionless response (MVDR) filter.

10. A method of training a first neural network for use in a hearing system, the method comprising:
providing one or more audio input devices within a region in which are positioned a plurality of sound sources;
receiving input signals at the one or more audio input devices, the input signals including undershot angle data as described elsewhere herein;
providing either the input signals, or intermediate signals based upon the input signals, to the first neural network;
generating by the first neural network a plurality of output signals;
processing the output signals, along with desired speaker clean speech data determined at least in part based upon the undershot angle data, at a loss processing block, to determine a plurality of weight signals; and
updating the first neural network based upon the weight signals.

11. The method of claim 10, wherein the receiving, providing, generating, processing, and updating are repeated until the training of the first neural network is complete, and wherein the first neural network is a deep neural network.

12. The method of claim 10,
wherein the one or more audio input devices include a plurality of microphones within a room simulation, the respective microphones being situated to respectively capture a sound field at respective different locations, and
wherein the audio input signals received by the one or more audio input devices include clean speech data, noise data, room characteristics data, speakers/listener characteristics data, and listener random head angle data that includes the undershot angle data.

13. A method of operating, during an inference mode, a hearing system including one or more memory devices configured to store a first neural network, the method comprising:
receiving audio input signals at one or more audio input devices, the audio input signals including audio information arising from a plurality of sound sources;
operating one or more processing devices in accordance with the first neural network to generate intermediate output signals that, to a higher degree than in the audio information, reflect or emphasize at least one desired sound source component of the audio information arising from a desired one of the sound sources of the plurality of sound sources determined to be the desired one of the sound sources at least indirectly based upon a first undershot angle evident from the audio information; and
generating, at one or more audio output devices, audio output signals based at least indirectly upon the intermediate output signals.

14. The method of claim 13, wherein the audio input devices are positioned on or associated with a listener human being having a listener center axis extending therefrom, wherein the plurality of sound sources includes a plurality of sound source human beings, and wherein the desired one of the sound sources is a first one of the sound source human beings.

15. The method of claim 14, wherein a plurality of additional axes extend respectively between the respective sound source human beings and the listener human being, wherein a plurality of angular differences exist respectively between the listener center axis and the respective additional axes of the plurality of additional axes, and wherein the first undershot angle is a first angular difference between the listener center axis and a first one of the additional axes that, at a first time, is smaller than each other one of the angular differences.

16. The method of claim 15,
wherein the operating includes determining a second undershot angle that is different from the first undershot angle, wherein the second undershot angle is a second angular difference between the listener center axis and a second one of the additional axes that, at a second time, becomes smaller than the first angular difference, and
wherein, at or substantially at the second time, a switching of the desired one of the sound sources switches from being the first one of the sound source human beings to being a second one of the sound source human beings associated with the second one of the additional axes.

17. The method of claim 13, wherein the intermediate output signals are linear filter coefficients, and further comprising multiplying or convolving the linear filter coefficients with the audio input signals or additional signals based at least indirectly upon the audio input signals to generate further intermediate output signals, wherein the audio output signals are based at least indirectly upon the further intermediate output signals.

18. The method of claim 13, wherein the intermediate output signals are statistics for a filter, and further comprising processing, by the filter with respect to which the statistics pertain, the statistics and the audio input signals or additional signals based at least indirectly upon the audio input signals to generate further intermediate output signals, wherein the audio output signals are based at least indirectly upon the further intermediate output signals.

19. The method of claim 18, wherein the filter is a beamforming filter that is minimum variance distortionless response (MVDR) filter.

20. The method of claim 13, wherein the first neural network is a deep neural network that was trained prior to operating in the inference mode, so as to be able to identify undershot angles and respective desired sound sources based upon received audio data.
